(19) United States
(12) Patent Application Publication
(10) Pub. No.: US 2005/0251422 A1
(43) Pub. Date: Nov. 10, 2005

(54) System and method for near real-time coding of hospital billing records

(76) Inventors: Jonathan G. Wolfman, Southbury, CT (US); Benjamin Singer, Bridgeport, CT (US)

Correspondence Address: Pitney Bowes Inc.;Intellectual Property & Technology Law Department, 35 Waterview Drive, P.O. Box 3000, Shelton, CT, 06484, US

(21) Appl. No.: 11/122,547

(22) Filed: May 5, 2005

Related U.S. Application Data
(60) Provisional application No. 60/568,766, filed on May 6, 2004.

(51) Int. Cl. G06F 17/60

(52) U.S. Cl. 705/2

(57) ABSTRACT

A method for real time communications between doctors and hospital personnel to resolve patient documentation issues by providing an imaged replica of a paper medical record that is being prepared by one or more doctors to one or more hospital personnel while the paper record is being prepared by the doctor; receiving by the hospital personnel the imaged replica; and reviewing by the hospital personnel the imaged replica so that the hospital personnel may determine whether or not the doctor provided sufficient information on the medical record for the hospital personnel to accurately code the medical record.

This Application claims the benefit of the filing date of U.S. Provisional Application No. 60/568,766 filed May 6, 2004, which is owned by the assignee of the present Application.

### FIELD OF THE INVENTION

This invention relates to the recovery of costs associated with patient care in a hospital and, more particularly, to the near real-time coding of hospital billing records.

### BACKGROUND OF THE INVENTION

Currently, hospitals recover costs for the services provided by processing a patient's medical record after he or she is discharged (i.e., sent home or transferred). Hospitals collect all the forms, notes, orders, test results, and other documentation for a patient and gather the foregoing in the records room where the file is cleaned up and sometimes scanned into an imaged database. After this, the record is presented to a person called a “coder.” Based on the material in the medical record, the coder generates diagnostic codes required by third party insurance companies, i.e., Blue Cross Blue Shield, Medicare and Medicaid, etc. To accomplish the foregoing, the coder may use either the original paper medical record or its imaged (scanned) replica.

Hospitals are failing to recover significant costs from the lack of specificity by doctors in the medical records. Through observation and interviews, it has been determined that hospital administrators are aware of this fact, but seem helpless to do anything about it. Since doctors focus on clinical efforts to making people healthy, documentation for cost recovery is secondary and not on their priority list without strong external influence; thus, a key to success in this area is to provide doctors with something they would be willing to use that does not significantly change the way they work.

Some of the problems encountered by the prior art in converting the medical charts into medical diagnosis codes for hospital cost recovery were: the coders often found the handwriting of the clinical staff illegible; diagnoses were not specified or large parts of a form are incomplete, i.e., specific language needed for diagnostic codes is not included in the medical record. The above problems in translating medical records to medical diagnostic codes prevented hospitals from fully recovering the costs for services that they have rendered. The foregoing problems are exacerbated by the coder's inability to obtain a copy of the medical record until after a patient is discharged, and when a doctor no longer fully remembers a patient's medical history.

The prior art attempted to solve the foregoing problems by having the coder and doctor communicate with one another using phone calls, email messages, and paper notes in the mail. Some of the problems with the prior art solution is as follows. After a patient is discharged, doctors often do not respond to these messages from coders, because these messages require that the doctor physically view the medical chart in the records room; the doctor has to re-familiarize himself or herself with the contexts and specifics of the patient's disease and treatment based on the medical record; the doctor has to read and respond to the coder's queries in writing; the doctor has to dictate a discharge summary from the medical record in a separate facility, and the doctor has to resubmit the medical record.

Doctors are hesitant to perform these activities, because doing so requires significant amounts of time that could be spent on seeing patients. Additionally, the doctor receives no feedback from this process unless there is a problem.

Coding medical records for insurance purposes is complicated by the volume of medical records, the time-sensitive nature of the billing process and paper records require in-house coding at the hospital. The coding of medical records is also complicated by the large body of complex rules and guidelines for coding that are promulgated by the governing consortium.

### SUMMARY OF THE INVENTION

This invention overcomes the disadvantages of the prior art by providing a system and method that facilitates communications between doctors and coders to resolve coding problems pertaining to medical records. Doctors may view and respond to inquiries from coders using paper and pen. The foregoing system may be accomplished by providing an imaged replica record of the paper medical record to the coder while the paper record is being prepared by the doctor.

### BRIEF DESCRIPTION OF THE DRAWING

FIG. 1 is a drawing of a medical record;

FIG. 2 is a drawing of medical record 11 of FIG. 1 after a hospital coder has read the medical record and found incomplete or illegible information in the medical record;

FIG. 3 is a block diagram illustrating the operation of this invention of this invention;

FIG. 4 is a flow chart showing the process flow of this invention; and

FIGS. 5A, 5B and 5C is a flow chart of query system 37 of FIG. 3.

### DETAILED DESCRIPTION OF THE PREFERRED EMBODIMENT

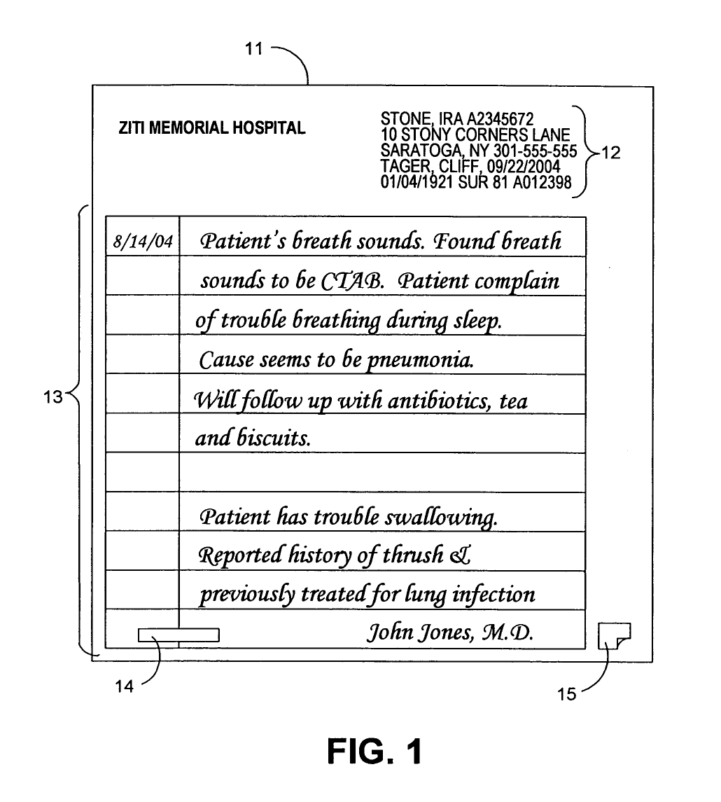

Referring now to the drawings in detail and more particularly to FIG. 1, the reference character 11 represents a page of a Ziti Memorial Hospital paper medical record for a patient named Ira Stone. Information that uniquely identifies Ira Stone is located in region 12 of medical record 11. Region 13 of medical record 11 includes information Doctor Jones obtained about patient Stone and Doctor Jones' diagnosis of patient Stone's condition. An identification code 14 is placed at a convenient location on medical record 11. Identification code 14 may be represented by alphanumeric characters, a bar code, a two-dimensional bar code, glyphs, etc. It would be obvious to one skilled in the art that document 11 may be printed on an Anoto paper page with an Anoto pattern on the paper page that represents a unique Anoto page address so that the Anoto pattern will be code 14.

Anoto systems use a digital pen that contains a camera and paper in a fashion that the pen's movement across the grid surface on the paper is stored as a series of map coordinates. The coordinates correspond to the exact location of the page that is being written on. When a mark is made on send box 15, medical record 11 with a digital pen, the pen is instructed to send the stored sequence of map coordinates which is translated into an image that will result in an exact copy of what is written on medical record 11 with the pen, which may be stored and displayed in a computer. Anoto systems are sold by Anoto Inc. of 470 Totten Pond Road, Waltham, Mass. 02451

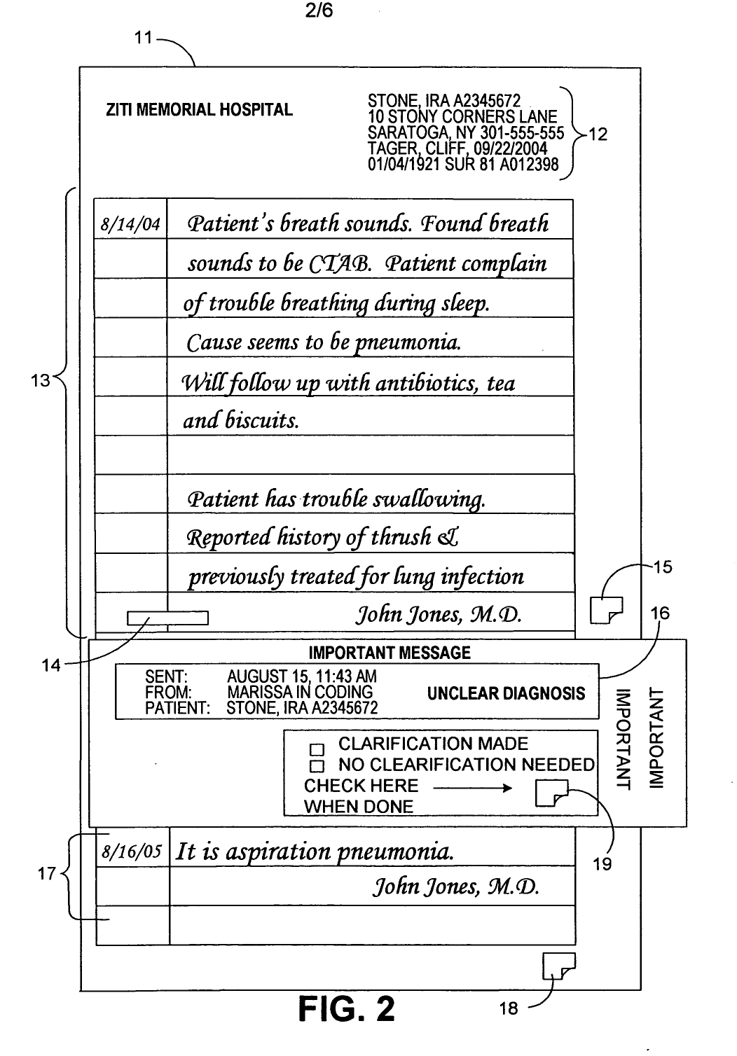

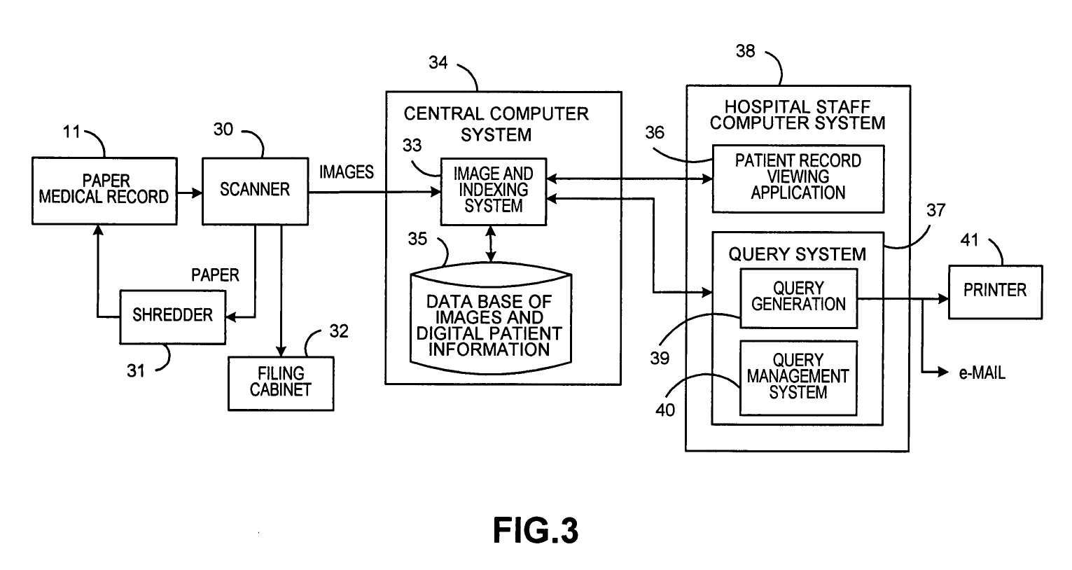

FIG. 2 is a drawing of medical record 11 of FIG. 1 after a hospital coder has read medical record 11 and found incomplete or illegible information in the medical record. The hospital coder will use this invention to create a communications dialog with Doctor Jones. The hospital coder was able to access medical record 11 from a data base of imaged or scanned patient records. The manner in which the foregoing is accomplished is described in the descriptions of FIGS. 2 and 3.

Hospital coder Marissa may attach a query, i.e., a brief memorandum 16 to medical record 11. Memorandum 16 may be attached directly to medical record 11 as shown in FIG. 2 or delivered to the doctor's office and/or the doctor's mail box and/or sent to the doctor via e-mail, via a personal data assistant, via a pager, via a cell phone, etc. Memorandum 16 indicates the information that is needed by Marissa to code the services performed by Doctor Jones so that Ziti Memorial Hospital may charge Ira Stone and/or Ira Stone's insurance the correct amount for the services that have been rendered to Ira Stone. Doctor Jones will answer the question posed in memorandum 16 by writing his answer in region 17. After Doctor Jones has responded to memorandum 16, he may mark send box 18 in order to signal the Query System 37 that Doctor Jones responded to memo 16 in region 17. Alternatively, when Doctor Jones checks done box 18 and the page is imaged by scanner 30, image processing software detects that Doctor Jones responded to memorandum 16.

After Hospital coder Marissa has reviewed Doctor Jones' response to memorandum 16, she may determine the proper insurance code. Hospital coder Marissa may then use the proper insurance code to prepare the relevant insurance forms. Optionally, Marissa may place the proper insurance code in medical record 11 so that Doctor Jones may be informed of the code.

In the event Hospital coder Marissa is unable to determine the name of the doctor who wrote something on medical record 11, she may determine the identity of the person whose handwriting could not be read by selecting from a master list of doctors working at or affiliated with the hospital the name of the doctor that looks similar to the signature; selecting from a filtered list of doctors obtained from the Admissions Department, the doctors likely to be working on the case; tracking and displaying the owner of the Anoto pen who authored the medical record; utilizing biometrics from the Anoto pen which identify the writer of the medical record; retrieving the time of day from the Anoto pen when the medical record was written, and selecting from doctors who were on the medical floor at that time.

FIG. 3 is a block diagram illustrating the operation of this invention. Paper medical record 11 is scanned by scanner 30 or read by an Anoto pen if medical record 11 was written on Anoto paper with an Anoto pen. At this point, shredder 31 may shred the paper version of medical record 11, or the paper version of medical record 11 may be stored in filling cabinet 32. Images from scanner 30 or the Anoto pen are transmitted to the imaging and indexing system 33 of central computer system 34. Data base of images and digital patent information 35 is coupled to imaging and indexing system 33. Indexing and imaging system 33 takes images from the Anoto pen or scanner 30 and places the images into Data Base of Images and Digital Patient Information 35. Indexing and imaging system 33 also retrieves the images and patient information for the Patient Record Viewing Application 36.

Data base of images and digital patent information 35 stores all images from the Anoto pen, Scanner 30 or other digital information associated with the patient record. All records in database 35 are associated uniquely with a patient and a patient visit episode. Image and index system 34 is coupled to patient record viewing application 36, which is stored in hospital staff computer system 38. Patient record viewing application 36 allows the authorized hospital personnel or coder to view the records in Data Base of Image and Digital Patient Information 35 presented in a fashion that is organized for human use. The patient data will be organized in sections, analogous to the manner consistent with the organization of a paper patient record. The Patient Viewing application 36, Data Base for the Images and Digital Patient Information 35, and image and indexing system 33 are examples of systems that are currently available. An example of the foregoing is the ChartMaxx for Medical Records system provided by MedPlus Inc. of 4690 Parkway Drive. Mason, Ohio 45040.

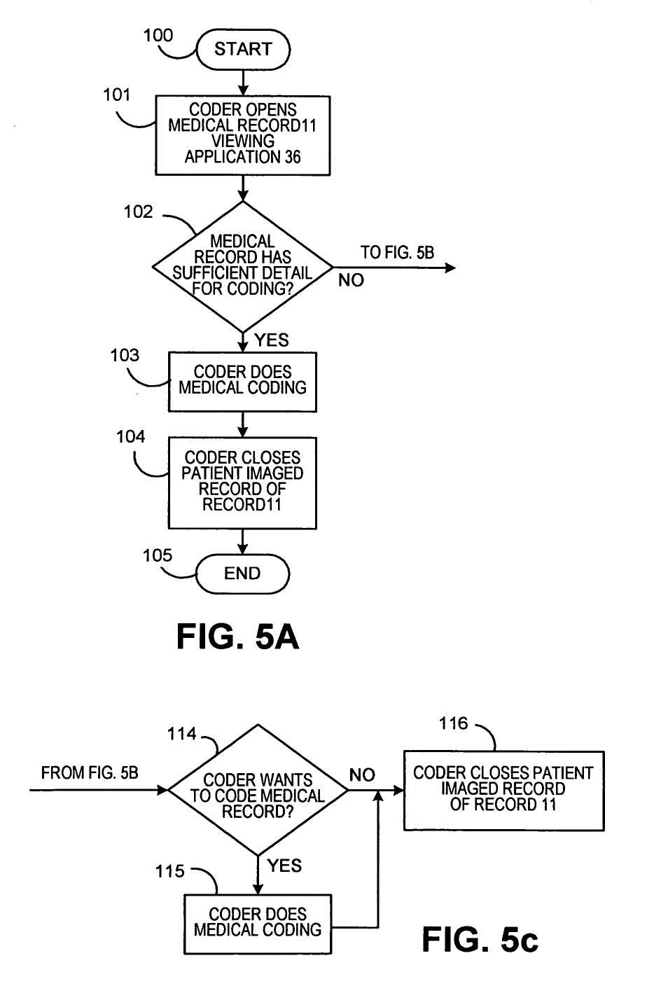

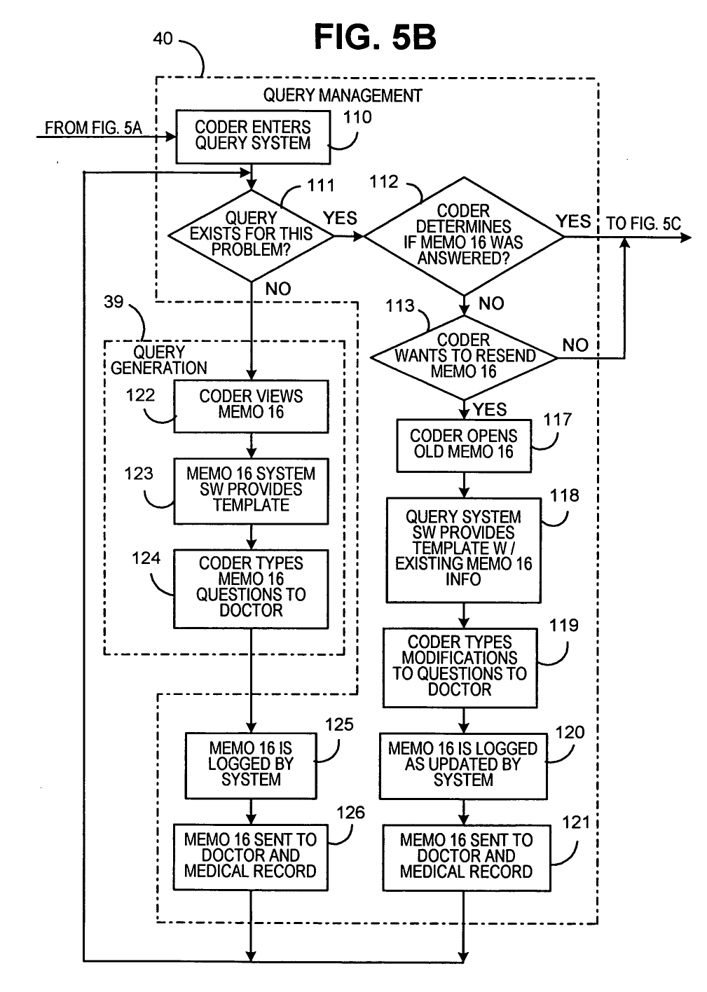

Image and index system 33 is also coupled to query system 37 of hospital staff computer system 38. Query system 37 is an extended communication system that allows authorized hospital personnel, i.e., a coder using imaged patient records for concurrent review or concurrent coding of patient records, to communicate with doctors and hospital clinical staff to make authorized changes to the medical records to help ensure that the documentation is accurate and allow legal coding of the medical record so that the hospital can effectively bill for the services that were provided to the patient. Query system 37 comprises query generation 39 and query management system 40. Query system 37 is more fully described in the description of FIG. 5.

The output of query generation 39 is memorandum 16 (FIG. 2). Memorandum 16 may be sent to Doctor John Jones via e-mail with or without medical record 11 attached thereto and/or a paper version of memorandum 16 with or without medical record 11 attached thereto may be printed by printer 41. The printed version of memorandum 16 with or without medical record 11 attached thereto will be delivered to Doctor John Jones.

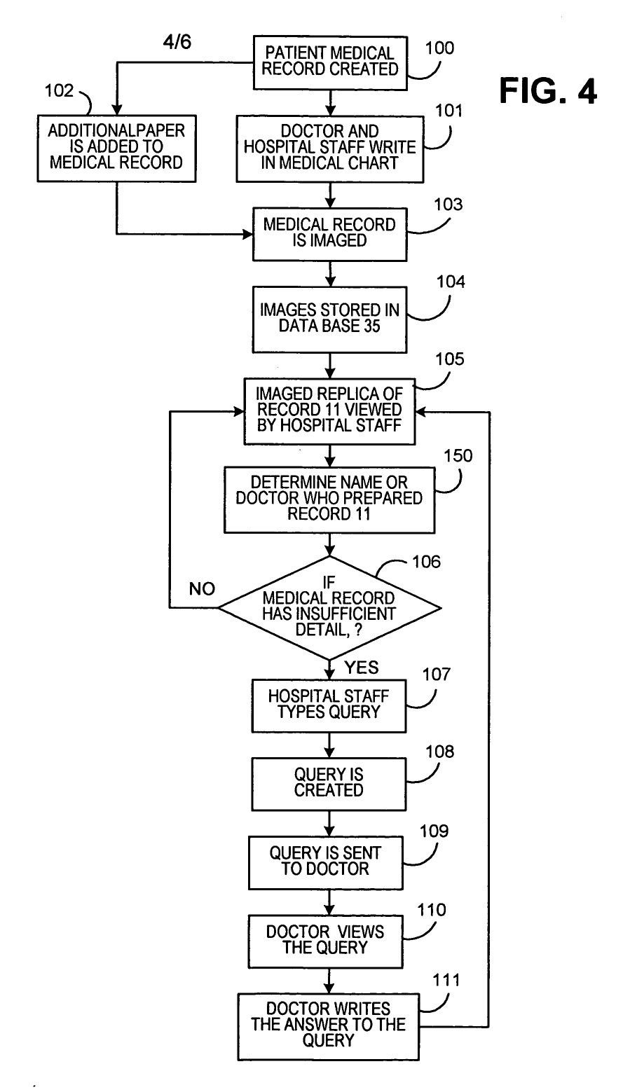

FIG. 4 is a flow chart showing the process flow of this invention. The process begins in step 100 where the patient's medical record 11 (FIG. 1) is created. In step 101, doctors and hospital staff write observations, test results and diagnosis of patient Ira Stone in medical record 11. In step 102, if doctors and/or hospital staff have to write additional information regarding patient Ira Stone in medical record 11, additional paper pages, if needed, are added to medical record 11. In step 103, all of the paper pages that comprise medical record 11 are imaged by a scanner or an Anoto pen. Then in step 104, the images that comprise medical record 11 are stored in Database of Images and Digital Patient Information 35.

Now in step 105 the imaged replica of medical record 11, are viewed by the hospital staff, i.e., doctors, nurses, administrative personnel, etc. Then in step 106 , one or more authorized members of the hospital staff determine whether or not the medical record has sufficient detail. If in step 106 it is determined that medical record 11 has sufficient detail, the process will go back to step 105, where the imaged replica of medical record 11 may be viewed by one or more authorized members of the hospital staff. If in step 106 it is determined that medical record 11 has insufficient detail, the process goes to step 107. In step 107, a member of the hospital staff types a query regarding information contained in medical record 11, i.e., memorandum 16 (FIG. 2). Then in step 108, the query i.e., memorandum 16 is created, and in step 109 the query is sent to Doctor Jones, i.e., the doctor from whom information is being requested. In step 110, Doctor Jones views the query. Then in step 111, Doctor Jones writes a response to the query in medical record 11. In step 112, Doctor Jones' answer to the query is then captured by Anoto pen or imaged with scanner 30, and the status of memorandum 16 is updated in the query management system 40. At this point, the answer to the query may be viewed by authorized members of the hospital staff in step 105.

FIGS. 5A. 5B and 5C is a flow chart of query system 37 of FIG. 3. Query system 37 is divided into two parts, the query generation 39 and the query management system 40. The Query Generation System 39 program takes information from the Patient Record Viewing Application 36 and populates a number of key parameters in a template for a query. System 37 then asks the coder to fill certain key information. System 37 will assist the coder by providing templates for questions but will allow the coder to free type in any text message. The resulting query will be a sent to the Query Management System 40. The Query Management System 40 program takes a newly generated query sent from the Query Generation system 39 and ensures that the query is printed for placement in the patient record. The Query Management system 40 also logs the Query and its key creation data to allow tracking of the query process with hospital personnel. The Query Management System 40 allows the Coder (Sender) to see the queries associated with the medical record current being examined in the Patient Record Viewing Application 36. The Query Management system 40 allows a Query to be re-sent if no answer has been received. When the query is re-sent, it can be sent using additional methods of delivery to other members of the hospital staff and sent.

The Query manager system 40 can send queries to the doctor or other medical staff in any of the following ways: printing to paper which is placed in the medical record, staff mail box, and other message center; create an electronic message with is sent to the doctor's or hospital staffs private email, Blackberry, Tablet, PC, Handheld PC and PDA; create a text message which is sent to the doctor's or hospital staffs pager, cellphone and other messaging device; translated to a voice message and left for the doctor or hospital staff in their personal voice mail.

The program starts in block 100 (FIG. 5A). Then the program goes to block 101 where the coder opens patient medical record 11 viewing application 36. Now the program goes to decision block 102. Decision block 102 determines whether or not medical record 11 has sufficient details for coding. If block 102 determines that medical record 11 has sufficient details for coding the program goes to block 103. In block 103, the coder does the medical coding. Then the program goes to block 104 where the coder closes the patient imaged record of medical record 11. Then this segment of the program ends in block 105. If block 102 determines that medical record 11 does not have sufficient details for coding, the program goes to block 110 (FIG. 5B) of query management system 40.

Now the program goes to decision block 111. Decision block 111 determines whether or not a query, i.e., memorandum 16, exists for this problem. If block 111 determines that a memorandum 16 exists for this problem, the program goes to decision block 112. Decision block 112 determines whether or not memorandum 16 was answered. If block 112 determines that memorandum 16 was not answered, the program goes to decision block 113. Decision block 113 determines whether or not the coder wants to resend memorandum 16. If block 113 determines that the coder wants to resend memorandum 16 or block 112 determines that memorandum 16 was answered, the program goes to decision block 114 (FIG. 5C). Decision block 114 determines whether or not the coder wants to code the medical record. If block 114 determines that the coder wants to code the medical record, the program goes to block 115 where the coder codes the medical record. At this point, the program goes to block 116 where the coder closes the patient imaged record of medical record 11. If block 114 determines that the coder does not want to code the medical record at this time the program goes to block 116. If block 113 determines that the coder wants to resend memorandum 16 the program goes to block 117.

In block 117 the coder opens old memorandum 16. Then the program goes to block 118, where a query system software provides templates with existing memorandum 16 information. Now the program goes to block 119 where the coder can type modifications to questions, if required, to the doctor. Then the program goes to block 120 where memorandum 16 is logged as updated by this system. Now the program goes to block 121 where memorandum 16 is sent to the doctor and the medical record. At this point, the program returns to the input of decision block 111.

If block 111 determines that a memorandum 16 does not exist for this problem, the program goes to block 122 of query generation 39. In block 122, the coder views a new memorandum 16. Then the program goes to block 123 where information for memorandum 16 is populated into a template. Now the program goes to block 124. In block 124 the coder types additional information into memorandum 16, including the questions to the doctor. Then the program goes to block 125 in query management system 40. In block 125, memorandum 16 is logged into the system. Now the program goes to block 126 where memorandum 16 is sent to the doctor and the medical record. At this point, the program returns to the input of decision block 111 in query management system 40.

The above specification describes a new and improved system and method that facilitates communications between doctors and coders to resolve coding problems pertaining to medical records. It is realized that the above description may indicate to those skilled in the art additional ways in which the principles of this invention may be used without departing from the spirit. Therefore, it is intended that this invention be limited only by the scope of the appended claims.

1. A method for real-time communications between doctors and hospital personnel to resolve patient documentation issues, which comprises the steps of:
(a) providing an imaged replica of a paper medical record that is being prepared by one or more doctors to one or more hospital personnel while the paper record is being prepared by the doctor;
(b) receiving by the hospital personnel the imaged replica;
(c) reviewing by the hospital personnel the imaged replica so that the hospital personnel may determine if the doctor provided sufficient information on the medical record for the hospital personnel to accurately code the medical record;
(d) preparing by hospital personnel a memorandum that is delivered to the doctor, requesting that the doctor provide additional information, if needed, for the hospital personnel to accurately code the medical record; and
(e) preparing by the doctor a response to the memorandum that is delivered to the hospital personnel, to provide the additional information to the hospital personnel so that the hospital personnel may accurately code the medical record.

2. The method claimed in claim 1, wherein the paper medical record is Anoto paper that has information written on the paper with an Anoto pen.

3. The method claimed in claim 1, wherein the paper medical record is imaged by a scanner.

4. The method claimed in claim 1, further including the step of:
determining the name of the doctor who prepared the medical record if hospital personnel are unable to determine the doctor's name.

5. The method claimed in claim 4, further including the step of: selecting from a master list of doctors working at or affiliated with the hospital the name of the doctor that looks similar to the signature.

6. The method claimed in claim 4, further including the step of:
selecting the name of the doctor from a filtered list of doctors obtained from the Admissions Department.

7. The method claimed in claim 4, further including the step of:
tracking and displaying the owner of an Anoto pen who authored the medical record.

8. The method claimed in claim 4, further including the step of:
utilizing biometrics from an Anoto pen which identify the writer of the medical record.

9. The method claimed in claim 4, further including the steps of:
(a) retrieving the time of day from an Anoto pen when the medical record was written; and
(b) selecting from doctors who where on the medical floor at the time the medical record was written.

10. The method claimed in claim 1, wherein the doctor's response is placed in the medical record.

11. The method claimed in claim 1, further including the step of:
placing the code in the medical record.

12. A system for real time communications between doctors and hospital personnel to resolve patient documentation issues, the system comprising:
(a) means for scanning a paper medical record that is being prepared by one or more doctors;
(b) a data base that stores the scanned medical record;
(c) means for displaying to hospital personnel an imaged replica of the stored record so that the hospital personnel may determine if the doctor provided sufficient information on the medical record for the hospital personnel to accurately code the medical record;
(d) means for the hospital personnel to provide a memorandum that is delivered to the doctor, requesting that the doctor provide additional information, if needed, for the hospital personnel to accurately code the medical record; and
(e) means for the doctor to respond to the memorandum that is delivered to the hospital personnel to provide the additional information to the hospital personnel so that the hospital personnel may accurately code the medical record.
